(19) United States
(12) Patent Application Publication
(10) Pub. No.: US 2007/0269133 A1
(43) Pub. Date: Nov. 22, 2007

(54) Image-data noise reduction apparatus and method of controlling same

(75) Inventor: Makoto Ooishi, Asaka-shi (JP)

Correspondence Address: BIRCH STEWART KOLASCH & BIRCH, PO BOX 747, FALLS CHURCH, VA, 22040-0747, US

(73) Assignee: FUJI FILM CORPORATION

(21) Appl. No.: 11/797,607

(22) Filed: May 4, 2007

(30) Foreign Application Priority Data
May 18, 2006 (JP) 2006-138778

(51) Int. Cl. G06K 9/40

(52) U.S. Cl. 382/275

(57) ABSTRACT

A CCD that outputs a video signal has an optical black area. The level of a video signal obtained from the optical black area is adopted as a black level in the execution of an offset correction. A video signal whose level is below an offset level used in the offset correction is thought of as representing a noise pixel. The noise pixel is detected before the video signal is clipped at the offset level by the offset correction. The noise pixel that has been detected undergoes pixel interpolation using pixels surrounding the noise pixel. Since the noise pixel is replaced by a pixel generated by pixel interpolation, noise is reduced in the image obtained.

### BACKGROUND OF THE INVENTION

1. Field of the Invention

This invention relates to an apparatus for reducing noise in image data, a method of controlling this apparatus and a control program therefor.

2. Description of the Related Art

Since high-sensitivity photography is required in recent digital still cameras, the effects of noise contained in an image can no longer be ignored. In particular, there are occasions where low- to mid-luminance noise appears as black dots in an image, and there are instances where this noise becomes conspicuous. In order to deal with this, there is prior art for reducing noise by applying a median filter to image data (see the specification of Japanese Patent Application Laid-Open No. 4-235472). However, since filtering is applied with regard to the entirety of the image data, there are instances where the resolution of the image declines.

### SUMMARY OF THE INVENTION

Accordingly, an object of the present invention is to reduce noise without diminishing image resolution.

According to a first aspect of the present invention, the foregoing object is attained by providing an apparatus for reducing noise in image data, comprising: a noise image data detecting device for detecting, as noise image data, image data having a level below an offset level in an offset correction for offsetting image data, which is output from a solid-state electronic image sensing device, using data, which is obtained from an optical black region of the solid-state electronic image sensing device, as black-level data; a noise reducing circuit, to which image data that has been output from the solid-state electronic image sensing device is input, for reducing noise in the noise image data that has been detected by the noise image data detecting device and outputting the resultant image data; and an offset correction circuit for applying the offset correction to the image data that has been output from the noise reducing circuit.

The first aspect of the present invention also supplies a control method suited to the above-described apparatus for reducing noise in image data. Specifically, the present invention provides a method of controlling an apparatus for reducing noise in image data, comprising the steps of: detecting, as noise image data by a noise image data detecting device, image data having a level below an offset level in an offset correction for offsetting image data, which is output from a solid-state electronic image sensing device, using data, which is obtained from an optical black region of the solid-state electronic image sensing device, as black-level data; inputting image data, which has been output from the solid-state electronic image sensing device, to a noise reducing circuit and reducing noise in the noise image data, which has been detected by the noise image detecting device, by the noise reducing circuit and outputting the resultant image data; and applying the offset correction to the image data, which has been output from the noise reducing circuit, by an offset correction circuit.

The first aspect of the present invention also provides a program for executing the method of controlling the apparatus for reducing noise in image data.

In image data that is output from a solid-state electronic image sensing device, data obtained from an optical black region of the solid-state electronic image sensing device is adopted as black-level data in execution of an offset correction. Image data having a level below the offset level in an offset correction should not exist. For this reason, image data having a level below the offset level is considered to be noise that appears as black dots in an image.

In accordance with the first aspect of the present invention, data below the offset level in an offset correction, which data is contained in image data that has been output from the solid-state electronic image sensing device, is detected as noise image data. The noise image data detected is subjected to noise reduction processing. Image data that has undergone the noise reduction processing is subjected to an offset correction. Not all of the image data that has been output from the solid-state electronic image sensing device is subjected to noise reduction. Rather, noise reduction processing is applied to noise image data that has been detected as noise. As a result, noise reduction processing can be executed without a decline in image resolution.

By way of example, the noise reducing circuit is an interpolating circuit for interpolating a noise pixel, which gives image data having a level below the offset level, using pixels in the vicinity of the noise pixel.

The apparatus may further comprise an interpolating circuit for interpolating a noise pixel, which gives image data having a level below the offset level and which is contained in pixels that constitute the image represented by the image data that has been output from the noise reducing circuit, using pixels in the vicinity of the noise pixel. In this case, the offset correction circuit would apply the offset correction to image data representing an image containing the pixel that has been interpolated by the interpolating circuit.

The apparatus further comprises a gamma correcting device for applying a gamma correction to image data that has been output from the solid-state electronic image sensing device. In this case, the noise reducing circuit would receive an input of image data that has been gamma-corrected by the gamma correcting device and would apply noise reduction to the noise image data that has been detected by the noise image data detecting device.

It may be so arranged that the noise reducing circuit receives an input of image data that has been output from the solid-state electronic image sensing device, outputs the noise image data, which has been detected by the noise image data detecting device, upon applying noise reduction processing by first noise reduction processing, and outputs image data, with the exception of noise image data, upon reducing noise by second noise reduction processing.

According to a second aspect of the present invention, the foregoing object is attained by providing an image sensing apparatus having a solid-state electronic image sensing device for sensing the image of a subject and outputting image data representing the image of the subject, the apparatus comprising: a noise image data detecting device for detecting, as noise image data, image data having a level below an offset level in an offset correction for offsetting image data, which is output from a solid-state electronic image sensing device, using data, which is obtained from an optical black region of the solid-state electronic image sensing device, as black-level data; a noise reducing circuit, to which image data that has been output from the solid-state electronic image sensing device is input, for reducing noise in the noise image data that has been detected by the noise image data detecting device and outputting the resultant image data; and an offset correction circuit for applying the offset correction to the image data that has been output from the noise reducing circuit.

In the second aspect of the present invention as well, in image data that has been output from a solid-state electronic image sensing device, data below an offset level employed in offset correction is detected as noise image data. The noise image data detected is subjected to noise reduction processing. Image data that has undergone the noise reduction processing is subjected to an offset correction. Not all of the image data that has been output from the solid-state electronic image sensing device is subjected to noise reduction. Rather, noise reduction processing is applied to noise image data that has been detected as noise. As a result, noise reduction processing can be executed without a decline in image resolution.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 illustrates the relationship between amount of light incident upon a CCD and level of an output signal;

FIG. 2 is a block diagram illustrating the electrical structure of a digital still camera;

FIG. 3 is a block diagram illustrating the electrical structure of a signal processing circuit;

FIG. 4 illustrates a honeycomb array;

FIG. 5 illustrates a Bayer array;

FIG. 6 illustrates the electrical structure of a signal processing circuit;

FIG. 7 illustrates an example of a pixel array;

FIGS. 8 and 9 are block diagrams illustrating the electrical structures of signal processing circuits; and

FIG. 10 is a flowchart illustrating noise reduction processing.

### DESCRIPTION OF THE PREFERRED EMBODIMENTS

The principles of the embodiments of the present invention will be described first.

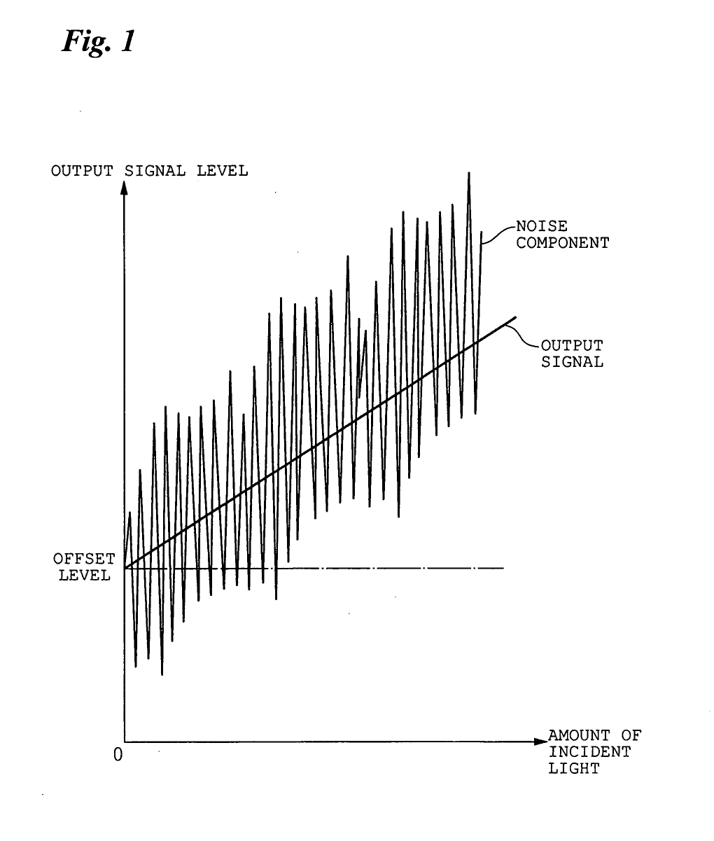

FIG. 1 illustrates the relationship between amount of light incident upon a solid-state electronic image sensing device and level of an output signal.

The level of the output signal rises in accordance with the amount of incident light. The solid-state electronic image sensing device includes an optical black region. A video signal obtained from the optical black region is treated as a black-level video signal. The video signal that has been output from the solid-state electronic image sensing device is subjected to an offset correction in a digital still camera in such a manner that the black-level video signal becomes zero. The offset level is defined in order to perform the offset correction. A signal whose level is below this offset level is clipped by the offset correction.

Since the level of the video signal obtained from the optical black region is the black level, a signal component having a level below the offset level should not exist. However, since the output signal contains a noise component, there are instances where a signal component having a level below the offset level is produced owing to the noise component. Thus, there are instances where a signal component having a level below the offset level appears as black-dot noise in the image represented by the output signal.

In the embodiment according to the present invention, a signal component having a level below the offset level is detected and the position of a pixel (a noise pixel) in the image represented by the detected signal component is found. The noise pixel found is one interpolated using pixels in the vicinity of the noise pixel (this is noise reduction processing). Since the signal component having the level below the offset level is detected before the offset correction, the noise pixel can be found.

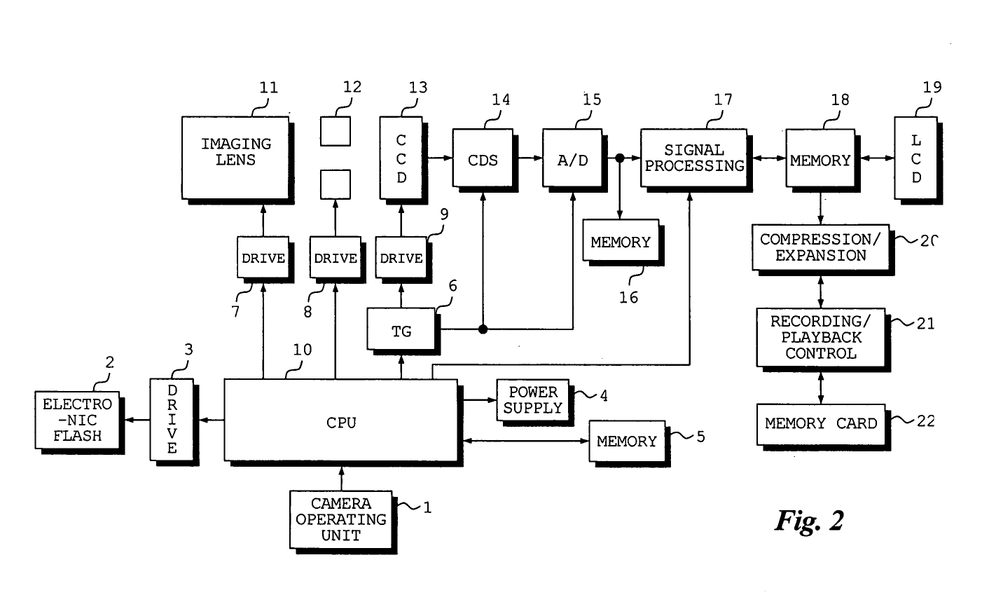

FIG. 2 is a block diagram illustrating the electrical structure of a digital still camera.

The operation of the overall digital still camera is controlled by a CPU 10.

The digital still camera includes a camera operating unit 1 having buttons such as a power button, a mode setting dial and a shutter-release button. Operating signals that are output from the camera operating unit 1 are input to the CPU 10.

The digital still camera also includes an electronic flash unit 2 for flash photography and a driving circuit 3 for controlling a light emission from the electronic flash unit 2. A power-supply circuit 4 for supplying power to each of the circuits of the digital still camera is connected to the CPU 10. A memory 5 for storing an operating program and prescribed data, etc., is also connected to the CPU 10. If the operating program has been recorded on a memory card 22, then the operating program is read from the memory card 22 and installed in the digital still camera, whereby the camera can be made to operate in a manner described later.

The CCD 13 is a single-chip CCD and, as will be described in detail later, includes color filters formed on a photoreceptor surface. It goes without saying that the CCD may be a three-chip CCD or a monochrome CCD. An imaging lens 11 and iris 12 are provided in front of the photoreceptor surface of the CCD 13. The in-focus position of the imaging lens 11 and the f-stop value of the iris 12 are controlled by driving circuits 7 and 8, respectively. The CCD 13 is driven by driving pulses supplied from a driving circuit 9. A timing generator 6 applies timing pulses to the driving circuit 9, a CDS (correlated double sampling) circuit 14, described later, and an analog/digital converting circuit 15, described later.

If the image sensing mode has been set, the image of the subject is formed on the photoreceptor surface of the CCD 13 and a video signal (color video signal) representing the image of the subject is output from the CCD 13. As mentioned above, the CCD 13 includes an optical black region and also outputs a video signal representing the optical black level.

The video signal that is output from the CCD 13 is subjected to correlated double sampling in the CDS circuit 14 and is then input to the analog/digital converting circuit 15. The latter converts the video signal to digital image data and applies the digital image data to a memory 16, where the data is stored. The image data is read out of the memory 16 and input to a signal processing circuit 17. The latter executes noise reduction processing such as detection of a noise pixel and pixel interpolation, etc., as described above. The details of processing executed by the signal processing circuit 17 will be described later.

The image data that has been output from the signal processing circuit 17 is applied to a liquid crystal display device 19 via a memory 18. The image of the subject obtained by imaging is displayed on the display screen of the liquid crystal display device 19.

If the shutter-release button is pressed, image data that has been output from the signal processing circuit 17 as mentioned above is applied to and stored temporarily in the memory 18. The image data is read from the memory 18 and input to a compressing/expanding circuit 20. The image data is compressed in the compressing/expanding circuit 20 and the compressed image data is then recorded on the memory card 22 by a recording/playback control circuit 21.

If the playback mode is set, compressed image data that has been recorded on the memory card 22 is read by the recording/playback control circuit 21. The compressed image data that has been read is expanded in the compressing/expanding circuit 20. The expanded image data is applied to the liquid crystal display device 19 via the memory 18. The image represented by the image data that has been recorded on the memory card 22 is displayed on the display screen of the liquid crystal display device 19.

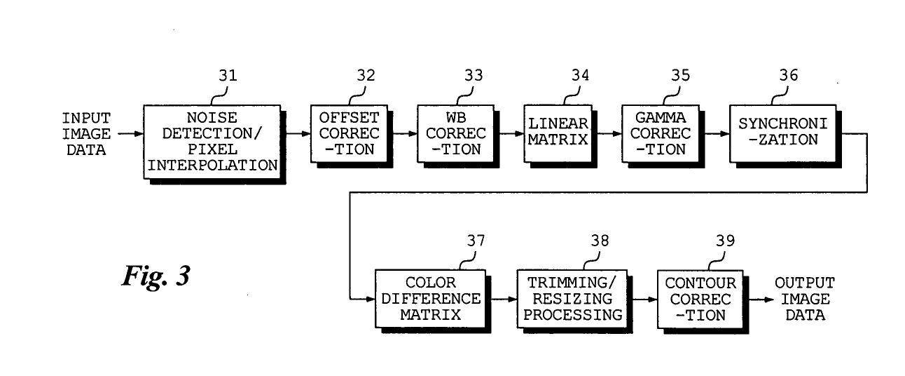

FIG. 3 is a block diagram illustrating the electrical structure of the signal processing circuit 17.

Image data (input image data) that has been applied to the signal processing circuit 17 as mentioned above is input to a noise-detecting/pixel-interpolating circuit 31. The latter detects image data (noise image data) having a level below the offset level and finds the position of a pixel (noise pixel) represented by the noise image data detected. The noise pixel found is interpolated using pixels in the vicinity of this noise pixel. The details of pixel interpolation processing will be described later.

Image data that has been output from the noise-detecting/pixel-interpolating circuit 31 is applied to an offset correction circuit 32 where, as described above, the image data is clipped at an offset level in such a manner that the black level of the image data will become a level of zero (this is an offset correction). Since noise-pixel detection is carried out before the offset correction, noise below the offset level and the black level can be distinguished from each other. A noise pixel can thus be detected.

The image data that has undergone the offset correction is subjected to a white balance correction in a white balance correcting circuit 33. The image data that has undergone the white balance correction is input to a gamma correcting circuit 35 via a linear matrix circuit 34. By applying the gamma correction, the gamma correcting circuit 35 converts 14-bit image data to 8-bit image data.

The gamma-corrected image data is subjected to synchronization processing in a synchronizing circuit 36. The image data is further applied to a color difference matrix 37, where the image data is subjected to a color correction. Image data that has been output from the color difference matrix 37 is subjected to trimming processing and resizing processing in a trimming/resizing processing circuit 38 so as to take on a desired size. The image data is further applied to a contour correcting circuit 39. Here the image data is subjected to a contour correction in such a manner that the contour of the image is emphasized. The resultant signal is output from the signal processing circuit 17.

In the embodiment described above, synchronization processing is executed in the synchronizing circuit 36. However, it goes without saying that in the case of a 3-chip CCD or CCD that outputs monochrome image data, synchronization processing is not executed.

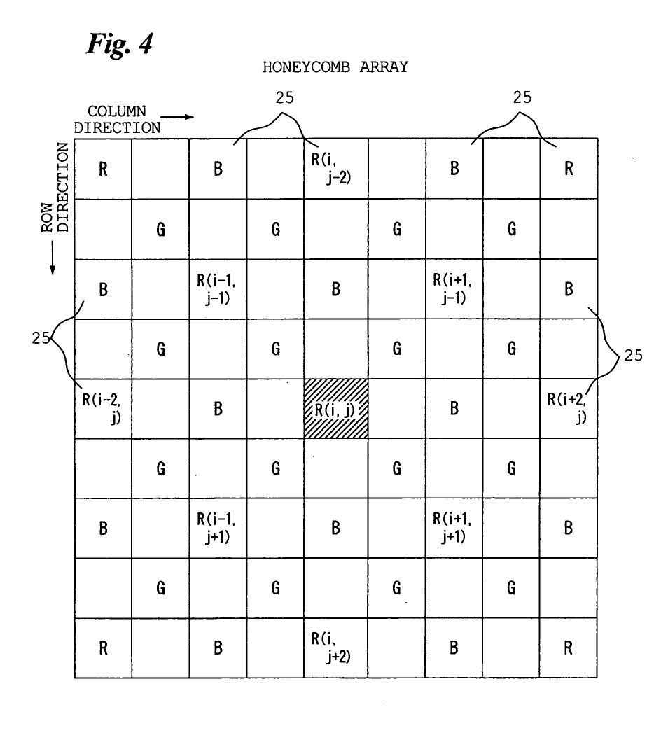

FIG. 4 illustrates a portion of the photoreceptor surface of the CCD 13.

The CCD shown in FIG. 4 is a so-called honeycomb array in which odd-numbered columns are provided with photodiodes 25 only in odd-numbered rows and even-numbered columns are provided with photodiodes 25 only in even-numbered rows. Of course, it may be so arranged that odd-numbered columns are provided with photodiodes 25 only in even-numbered rows and even-numbered columns are provided with photodiodes 25 only in odd-numbered rows.

The photoreceptor surfaces of the photodiodes 25 are provided with filters (denoted by the character “R”) having a characteristic that passes a red color component of light, filters (denoted by the character “G”) having a characteristic that passes a green color component of light or filters (denoted by the character “B”) having a characteristic that passes a blue color component of light.

Assume that a pixel R(i,j) corresponding to a central photodiode 25 among these photodiodes has been detected as the above-mentioned noise pixel. The noise pixel R(i,j) is obtained from a photodiode 25 on which the filter that passes the red component has been formed. Accordingly, pixel interpolation of the noise pixel R(i,j) is performed using pixels R(i−2,j), R(i+2,j), R(i,j−2), R(i,j+2), R(i−1,j−1), R(i+1,j+1), R(i−1,j+1) and R(i+1,j−1), which are obtained from the photodiodes 25 on which the red filters have been formed, from among the pixels in the vicinity of the noise pixel.

First, by using Equations 1 to 4 below, differentials ΔEv(H), ΔEv(V), ΔEv(NW) and ΔEv(NE) are calculated between the level of the noise pixel R(i,j), which is the target of interpolation, and average levels of pixels located in the horizontal direction, vertical direction, northwest direction and northeast direction of the noise pixel R(i,j).

ΔEv(H)=|R(i,j)−{R(i−2,j)+R(i+2,j)}/2| Eq. 1

ΔEv(V)=|R(i,j)−{R(i,j−2)+R(i,j+2)}/2| Eq. 2

ΔEv(NW)=|R(i,j)−{R(i−1,j−1)+R(i+1,j+1)}/2| Eq. 3

ΔEv(NE)=|R(i,j)−{R(i−1,j+1)+R(i+1,j−1)}/2| Eq. 4

In order to so arrange it that pixel interpolation of the noise pixel R(i,j) will be performed using pixels for which the level difference relative to the noise pixel R(i,j) is small, a differential ΔEv(1) for which the differential value is smallest is selected from among the differentials ΔEv(H), ΔEv(V), ΔEv(NW) and ΔEv(NE) calculated by Equations 1 to 4, respectively. The noise pixel R(i,j) is interpolated by Equation 5 below using pixels R1 and R2 used in order to calculate the selected differential ΔEv(1).

R(i,j)=(R1+R2+1)/2 Eq. 5

In Equation 5, 1 is added on because the pixel level is rounded up (or rounded down).

By way of example, if ΔEv(H) is the smallest value, then Equation 5 is expressed as Equation 6 below.

R(i,j)={R(i−2,j)+R(i+2,j)+1}/2 Eq. 6

Interpolation of the noise pixel is thus carried out. Pixel interpolation is performed in similar fashion to thereby eliminate noise in the noise pixel also in cases where the noise pixel is another pixel.

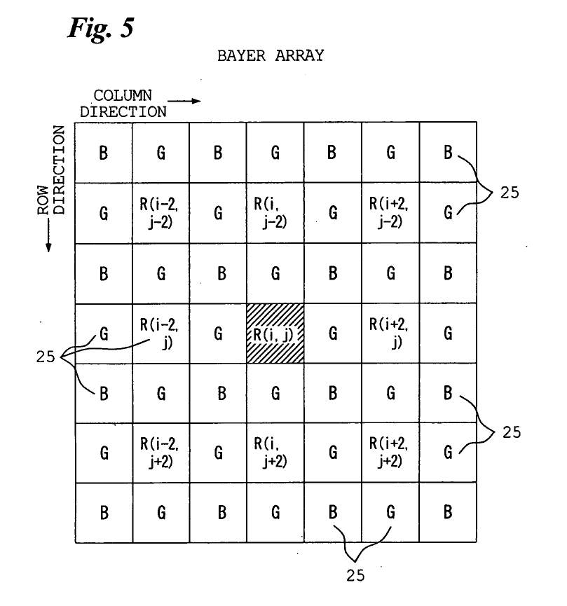

FIG. 5 illustrates another example of the photoreceptor surface of a CCD. This CCD has photodiodes in an Bayer array.

Here the photoreceptor surface of the CCD is provided with the photodiodes 25 in all rows and columns. In a manner similar to that illustrated in FIG. 4, the photoreceptor surfaces of the photodiodes 25 are formed to have filters R that pass the red color component of light, filters G that pass the green color component of light and filters B that pass the blue color component of light.

The central pixel R(i,j) is the noise pixel and is the pixel that is to undergo interpolation. Pixels R(i−2,j), R(i+2,j), R(i,j−2), R(i,j+2), R(i−2,j−2), R(i+2,j+2), R(i−2,j+2) and R(i+2,j−2) on which filters having a characteristic that passes the red color component, which is the same as that passed by the noise pixel R(i,j), have been formed are placed in the vicinity of the noise pixel R(i,j). It will be understood that the noise pixel R(i,j) is interpolated using these pixels in the manner indicated by Equations 1 to 5 above.

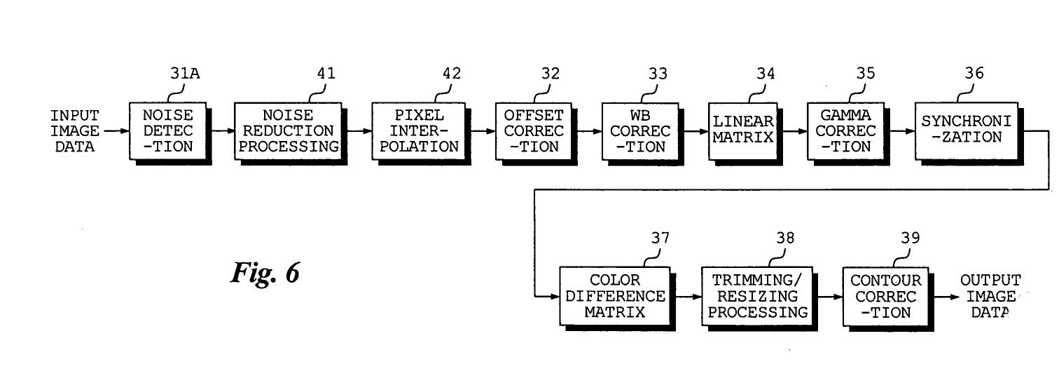

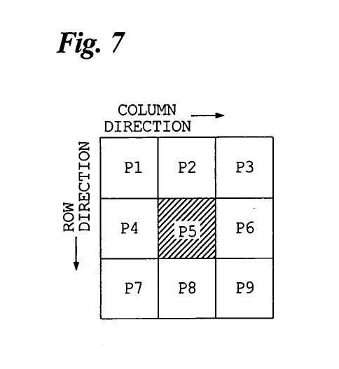

FIGS. 6 and 7 illustrate another embodiment.

FIG. 6 is a block diagram illustrating the electrical structure of the signal processing circuit 17. Circuits in FIG. 6 identical with those shown in FIG. 3 are designated by like reference characters and need not be described again.

In the signal processing circuit shown in FIG. 3, noise detection and pixel interpolation are carried out in the noise-detecting/pixel-interpolating circuit 31. In the signal processing circuit of FIG. 6, however, noise detection is performed in a noise detecting circuit 31A and pixel interpolation is performed in a pixel interpolating circuit 42 separate from the noise detecting circuit 31A. A noise reduction processing circuit 41 is provided between the noise detecting circuit 31A and the pixel interpolating circuit 42. Image data that has undergone noise reduction in the reduction processing circuit 41 is input to the pixel interpolating circuit 42. Noise reduction processing may be of the ordinary type, and the noise reduction processing method is not particularly limited.

With the signal processing circuit shown in FIG. 3, detection of a noise pixel and pixel interpolation are performed in the single noise-detecting/pixel-interpolating circuit 31. Consequently, if a pixel used in order to interpolate the noise pixel is itself noise, the noise of the pixel produced by interpolation may not be diminished in comparison with that prior to interpolation. With the signal processing circuit illustrated in FIG. 6, the noise pixel is interpolated using image data in which noise has been reduced. The noise in the pixel generated by interpolation, therefore, is reduced in comparison with that prior to interpolation.

FIG. 7 illustrates an example of a pixel array.

Pixels P1 to P9 have been defined in column and row directions. Among the pixels P1 to P9, the central pixel P5 is a noise pixel and is the pixel to undergo interpolation.

The noise pixel P5 undergoes pixel interpolation using any one set of pixels P1 to P4 and P6 to P9 surrounding the noise pixel P5 in the manner described above. However, if pixels in the set used in pixel interpolation are themselves noise pixels, then the pixel produced by interpolation in the manner described above will still contain noise. In this embodiment, pixel interpolation processing is executed after noise reduction processing is executed, as mentioned above. Accordingly, even if the pixels in the set used in pixel interpolation are noise pixels, the noise in these pixels is reduced. This means that pixel interpolation is performed using pixels from which noise has been reduced.

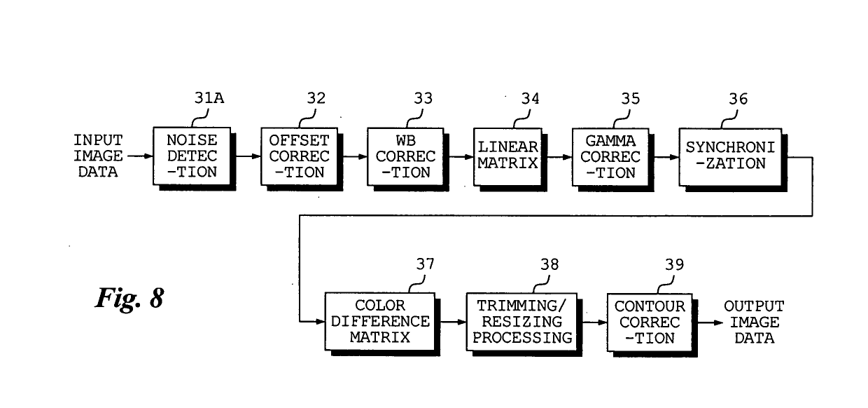

FIG. 8 is a block diagram illustrating the electrical structure of a signal processing circuit according to a further embodiment. Circuits in FIG. 8 identical with those shown in FIG. 3 are designated by like reference characters and need not be described again.

The pixel interpolating circuit 42 is provided separately of the noise detecting circuit 31A in this embodiment as well. Here the pixel interpolating circuit 42 is provided on the output side of the gamma correcting circuit 35 and pixel interpolation is performed in the pixel interpolating circuit 42 with regard to gamma-corrected image data. As mentioned above, image data is converted from 14-bit data to 8-bit data by the gamma correction. The pixel interpolating circuit 42, therefore, can be reduced in size. The image data that has undergone pixel interpolation by the pixel interpolating circuit 42 is subjected to synchronization processing in the synchronizing circuit 36.

The position of the noise pixel that has been detected in the noise detecting circuit 31A is stored in the memory 5 of the digital still camera. It goes without saying that the pixel interpolation in the pixel interpolating circuit 42 is performed based upon this position.

It goes without saying that the noise reducing circuit may be provided on the output side of the noise detecting circuit 31A in the circuit of FIG. 8 in a manner similar to that shown in FIG. 6.

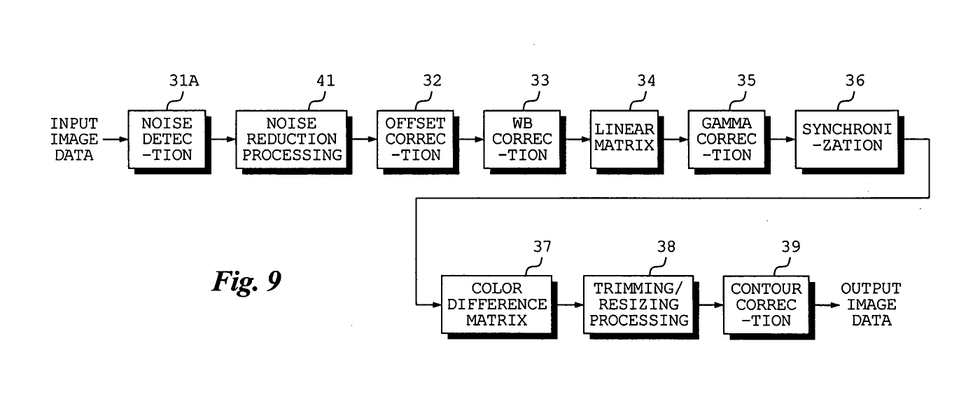

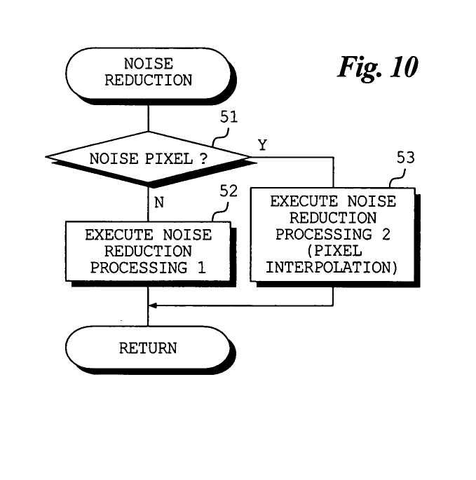

FIGS. 9 and 10 illustrate yet another embodiment.

FIG. 9 is a block diagram illustrating the electrical structure of the signal processing circuit. Circuits in FIG. 9 identical with those shown in FIG. 3 are designated by like reference characters and need not be described again.

In this embodiment, the above-mentioned noise pixel is subjected to noise reduction processing based upon pixel interpolation and pixels other than a noise pixel are subjected to ordinary noise reduction processing. Although the noise pixel is subjected to noise reduction processing based upon pixel interpolation, it is not subjected to ordinary noise reduction processing.

Image data that has been output from the noise detecting circuit 31A is input to the reduction processing circuit 41. Here image data representing pixels other than the noise pixel is subjected to ordinary noise reduction processing. This is followed by carrying out offset correction, etc. Since a noise pixel does not undergo ordinary noise reduction processing, noise reduction processing can be executed rapidly.

Gamma-corrected image data is input to the pixel interpolating circuit 42, which applies pixel interpolation processing to the noise pixel.

FIG. 10 is a flowchart illustrating noise reduction processing.

It is determined whether image data is indicative of a noise pixel (step 51). If a pixel is not a noise pixel (“NO” at step 51), noise reduction processing (first noise reduction processing) is executed in the reduction processing circuit 41 in the manner described above (step 52). If a pixel is a noise pixel (“YES” at step 51), then pixel interpolation (second noise reduction processing) is executed in the pixel interpolating circuit 42 in the manner described above (step 53).

As many apparently widely different embodiments of the present invention can be made without departing from the spirit and scope thereof, it is to be understood that the invention is not limited to the specific embodiments thereof except as defined in the appended claims.

What is claimed is:

1. An apparatus for reducing noise in image data, comprising:
a noise image data detecting device for detecting, as noise image data, image data having a level below an offset level in an offset correction for offsetting image data, which is output from a solid-state electronic image sensing device, using data, which is obtained from an optical black region of the solid-state electronic image sensing device, as black-level data;
a noise reducing circuit, to which image data that has been output from said solid-state electronic image sensing device is input, for reducing noise in the noise image data that has been detected by said noise image data detecting device and outputting the resultant image data; and
an offset correction circuit for applying the offset correction to the image data that has been output from said noise reducing circuit.

2. The apparatus according to claim 1, wherein said noise reducing circuit is an interpolating circuit for interpolating a noise pixel, which gives image data having a level below the offset level, using pixels in the vicinity of the noise pixel.

3. The apparatus according to claim 1, further comprising an interpolating circuit for interpolating a noise pixel, which gives image data having a level below the offset level and which is contained in pixels that constitute the image represented by the image data that has been output from said noise reducing circuit, using pixels in the vicinity of the noise pixel;
wherein said offset correction circuit applies the offset correction to image data representing an image containing the pixel that has been interpolated by said interpolating circuit.

4. The apparatus according to claim 1, further comprising a gamma correcting device for applying a gamma correction to image data that has been output from the solid-state electronic image sensing device;
wherein said noise reducing circuit receives input of image data that has been gamma-corrected by said gamma correcting device and applies noise reduction to the noise image data that has been detected by said noise image data detecting device.

5. The apparatus according to claim 1, wherein said noise reducing circuit receives input of image data that has been output from the solid-state electronic image sensing device, outputs the noise image data, which has been detected by said noise image data detecting device, upon applying noise reduction processing by first noise reduction processing, and outputs image data, with the exception of noise image data, upon reducing noise by second noise reduction processing.

6. An image sensing apparatus having a solid-state electronic image sensing device for sensing the image of a subject and outputting image data representing the image of the subject, said apparatus comprising:
a noise image data detecting device for detecting, as noise image data, image data having a level below an offset level in an offset correction for offsetting image data, which is output from a solid-state electronic image sensing device, using data, which is obtained from an optical black region of the solid-state electronic image sensing device, as black-level data;
a noise reducing circuit, to which image data that has been output from the solid-state electronic image sensing device is input, for reducing noise in the noise image data that has been detected by said noise image data detecting device and outputting the resultant image data; and
an offset correction circuit for applying the offset correction to the image data that has been output from said noise reducing circuit.

7. A method of controlling an apparatus for reducing noise in image data, comprising the steps of:
detecting, as noise image data by a noise image data detecting device, image data having a level below an offset level in an offset correction for offsetting image data, which is output from a solid-state electronic image sensing device, using data, which is obtained from an optical black region of the solid-state electronic image sensing device, as black-level data;
inputting image data, which has been output from the solid-state electronic image sensing device, to a noise reducing circuit and reducing noise in the noise image data, which has been detected by the noise image detecting device, by the noise reducing circuit and outputting the resultant image data; and
applying the offset correction to the image data, which has been output from the noise reducing circuit, by an offset correction circuit.

8. A program for controlling an apparatus for reducing noise in image data in such a manner that said apparatus executes the following steps:
detecting, as noise image data, image data having a level below an offset level in an offset correction for offsetting image data, which is output from a solid-state electronic image sensing device, using data, which is obtained from an optical black region of the solid-state electronic image sensing device, as black-level data;
inputting image data that has been output from the solid-state electronic image sensing device, reducing noise in the noise image data that has been detected by said noise image data detecting device and outputting the resultant image data; and
applying the offset correction to the image data that has been output from said noise reducing circuit.
